(19) United States
(12) Patent Application Publication
(10) Pub. No.: US 2020/0190778 A1
(43) Pub. Date: Jun. 18, 2020

(54) OUTLET SET FOR SANITARY FITTING, SANITARY FITTING ASSEMBLY, USE OF A SANITARY INSERT AND SANITARY FITTING ASSEMBLY SET

(71) Applicant: Neoperl GmbH, Mullheim (DE)

(72) Inventor: Thomas Vogeli, Bubendorf (CH)

(73) Assignee: Neoperl GmbH, Mullheim (DE)

(21) Appl. No.: 16/478,634

(22) PCT Filed: Jan. 19, 2018
(86) PCT No.: PCT/EP2018/051318

§ 371 Date: Jul. 17, 2019

(30) Foreign Application Priority Data
Mar. 10, 2017 (DE) 20 2017 101 373.1

(51) Int. Cl. E03C 1/084; E03C 1/086

(52) U.S. Cl. CPC E03C 1/084; B05B 1/3006; E03C 1/086

(57) ABSTRACT

A sanitary fitting assembly (5) having a sanitary fitting part (11) with a threaded portion (8) into which an outlet mouthpiece (2) is screwed, an insert (1) and a sealing ring (3) being inserted into the outlet mouthpiece (2). The axial length of the insert (1) is such that on the outflow end (10) a region (14) protrudes axially over the outlet mouthpiece (2). As a result, the protruding region (14) is visible from an observation position (12) at an angle (A) that is greater than 20°.

### BACKGROUND

The invention relates to an outlet set for a sanitary fitting comprising a sanitary insert on a sanitary fitting outlet, the insert being inserted in an outlet mouthpiece and the outlet mouthpiece being fastened on a sanitary fitting part.

Such outlet sets for sanitary fittings are known and are used for terminating a sanitary fitting outlet on a sanitary fitting, whereby a sanitary fitting assembly is obtained.

The invention also relates to a use of a sanitary insert on a sanitary fitting outlet, the insert being inserted in an outlet mouthpiece and the outlet mouthpiece being fastened on a sanitary fitting part.

Such outlet sets for sanitary fittings and sanitary fitting assemblies are known and are used for example to produce a pleasant form of jet. The inserts tend after some time to become contaminated and must therefore be exchanged regularly if they are used in hygienically sensitive areas of use, for example in hospitals.

### SUMMARY

The invention is based on the object of improving the functional properties of a sanitary fitting assembly.

To achieve the object, according to the invention are provided. In particular, in the case of an outlet set for a sanitary fitting of the type described at the beginning, to achieve the stated object it is consequently provided according to the invention that the insert is made to be of such a length in an inserting direction that, in the position for use, it is visible from a viewing direction that is arranged higher than the outlet mouthpiece. It is in this way achievable that, even after fitting, the inserted insert remains externally visible from a normal viewing position. It can consequently be easily seen which insert has been fitted, without mirrors or the like having to be used. It is consequently easy to monitor an exchange, which increases the functional properties. The position for use is in this case often an alignment of the insert in which a jet that is formed is directed downward, or at least substantially downward or obliquely downward.

The invention consequently makes it possible to dispense with the previously required use of trained specialist staff for monitoring compliance with hygiene routines to be carried out at regular intervals, in which the inserts are to be exchanged, for example in hospitals or similar facilities with high hygiene requirements. With the invention, it can quickly be checked whether a change of the insert has actually been carried out, since it can be seen immediately whether the change has been made on the basis of an inappropriate color or similar visual indication for a respective hygiene interval—for example of a week or a month. By being visible in the way according to the invention, the check can be carried out easily, and in particular without removing the insert. Consequently, costs that would be incurred for the use of specialist personnel can be saved.

In one configuration of the invention it may be provided that the length is dimensioned such that the insert protrudes through the outlet mouthpiece and projects beyond an outflow-side termination of the outlet mouthpiece. Consequently, a region of the insert is visible even when a substantially cylindrical outlet mouthpiece is used.

In one configuration of the invention it may be provided that the length is dimensioned such that the insert is visible from a viewing direction of at least 20° to the horizontal at an outflow-side termination, for example the already mentioned termination, of the outlet mouthpiece. Consequently, a visual check is made possible from customary viewer position of a user of a sanitary fitting. Preferably, an angle of at least 30°, particularly preferably at least 45°, is provided. This makes a visual check of the insert possible even from a viewer position that is arranged very close to and/or above the sanitary fitting.

In one configuration of the invention it may be provided that the insert defines on the outflow side a peripheral outer edge. Consequently, a visual check is possible from all sides, irrespective of an orientation of installation. It is particularly favorable if the insert has a substantially planar outflow side. Consequently, conventional inserts with an end face that is substantially planar, that is to say for example planar apart from haptically imperceptible elevations, or is completely planar, can be used.

In one configuration of the invention it may be provided that the insert is a jet and/or flow regulator. Consequently, with the invention inserts with which there is a high risk of soiling can be monitored for being changed regularly.

In one configuration of the invention it may be provided that the outlet mouthpiece is produced from metal and/or opaque plastic. Consequently, conventional outlet mouthpieces and/or outlet mouthpieces that can be easily produced can be used.

In one configuration of the invention it may be provided that there is an exchange insert, with which the insert can be replaced, the exchange insert being of a different color than the insert, at least in a region that is externally visible in the position for use. Color codes that change regularly are especially suitable for allowing a prescribed exchange to be easily monitored. The invention makes easy implementation possible here, without any great structural modifications being made for example to a body of a sanitary fitting, to an outlet mouthpiece and/or to the insert.

Consequently, a sanitary fitting assembly comprising a sanitary fitting outlet and an outlet set for a sanitary fitting according to the invention can be formed, in particular as described above and/or as claimed in one of the claims directed to an outlet set for a sanitary fitting.

As an alternative or in addition, the features of the independent claim, directed to a use, are provided for achieving the stated object. In particular, it is consequently provided according to the invention to achieve the stated object in the case of the use described at the beginning that the insert is made to be of such a length in an inserting direction that, in the position for use, it is visible from a viewing direction associated with a position of an observer that is arranged higher than the outlet mouthpiece. A visual check is consequently possible without optical aids from a normal viewer position with respect to a receiving sanitary fitting and without removal of the sanitary fitting.

In one configuration of the invention it may be provided that the length is dimensioned such that the insert protrudes through the outlet mouthpiece and projects beyond an outflow-side termination of the outlet mouthpiece. Consequently, conventional outlet mouthpieces and/or outlet mouthpieces of a simple geometrical form can be used. Thus, conventional inserts can also be combined with shortened outlet mouthpieces.

In one configuration of the invention it may be provided that the length is dimensioned such that the insert is visible from a viewing direction of at least 20°, preferably at least 30°, particularly preferably at least 45°, to the horizontal at an outflow-side termination, in particular the already mentioned termination, of the outlet mouthpiece. This makes a simple unaided visual check possible from a comparatively close viewer position obliquely above the fitted insert.

In one configuration of the invention it may be provided that the insert defines on the outflow side a peripheral outer edge, in particular has a substantially planar outflow side. There is no need for additional attachments to make it visible.

In one configuration of the invention it may be provided that the insert is a jet and/or flow regulator. Consequently, many applications can be covered, in particular unthrottled and/or non-flow-regulated jet regulators and/or flow-regulated and/or throttled jet regulators. However, the invention can also be used in the case of jet formers without additional regulating functions.

In one configuration of the invention it may be provided that the outflow nozzle is produced from metal and/or opaque plastic. Consequently, an outflow nozzle that can be easily produced and is often already present can be used.

In one configuration of the invention it may be provided that the insert as an exchange insert, of a different color at least in a region that is externally visible in the position for use, replaces a used insert. A visual check can consequently also be carried out without any instruction if a prescribed or agreed use of color codes for each time interval is known.

The invention consequently includes a sanitary fitting assembly set according to the invention, in particular for a sanitary fitting assembly as described above and/or as claimed in one of the claims directed to a sanitary fitting assembly, comprising an outlet mouthpiece and at least two inserts, which can be alternatively inserted into the outlet mouthpiece and which are differently colored in a corresponding region that remains externally visible in each case in the position for use. Preferably, a use according to the invention, in particular as described above and/or as claimed in one of the claims directed to a use, can be carried out. One of the inserts may be used here, for example as an exchange insert.

### BRIEF DESCRIPTION OF THE DRAWINGS

The invention will now be described in more detail on the basis of an exemplary embodiment, but is not restricted to this exemplary embodiment. Further exemplary embodiments are provided by combining the features of one or more of the claims with one another and/or with one or more features of the exemplary embodiment.

In the figures:

FIG. 1 shows an outlet set for a sanitary fitting according to the invention comprising a sanitary insert, an outlet mouthpiece and a sealing ring in an exploded representation,

FIG. 2 shows the arrangement as shown in FIG. 1, assembled and in an perspective view from below the outlet mouthpiece,

FIG. 3 shows the arrangement as shown in FIG. 2 in a longitudinal section,

FIG. 4 shows the arrangement as shown in FIG. 2 in an perspective view from below the outlet mouthpiece, and

FIG. 5 shows a sanitary fitting assembly according to the invention.

### DETAILED DESCRIPTION

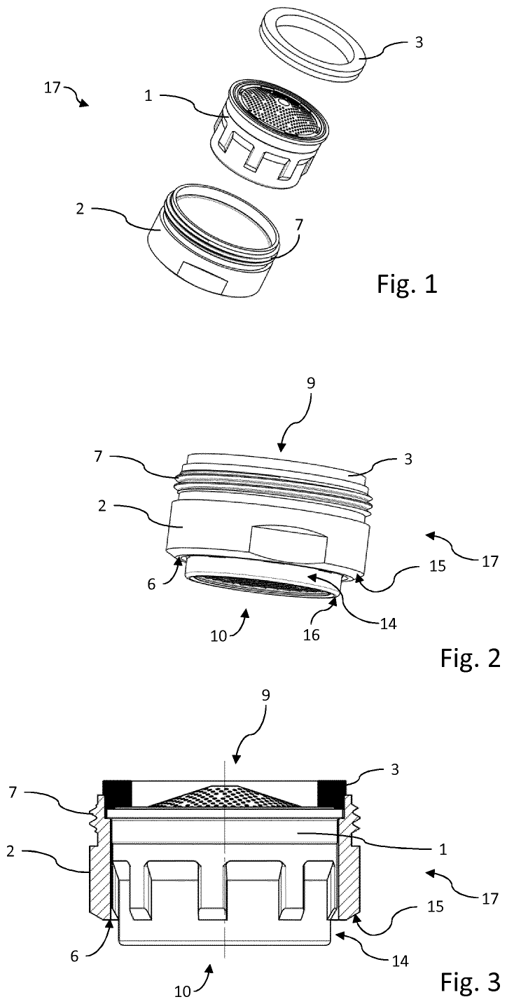

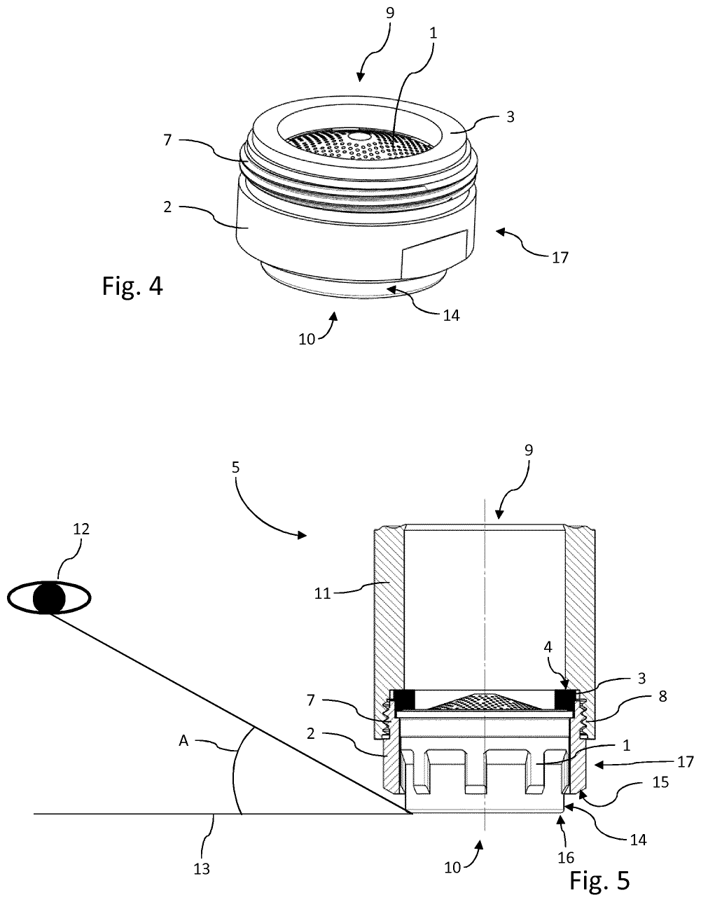

FIGS. 1 to 4 show a sanitary insert 1 for inserting into a sanitary fitting assembly 5 according to the invention. The insert 1 may be formed for example as a jet regulator and/or flow regulator.

The insert 1 is inserted in an outlet mouthpiece 2 on the inflow side 9. The outlet mouthpiece 2 has a mating thread 7, which can be screwed with a corresponding thread 8 of a sanitary fitting assembly 5 (FIG. 5). In the example, the mating thread 7 is formed as an external thread, while the thread 8 is an internal thread. In further exemplary embodiments, the thread 8 may be an external thread and the mating thread 7 an internal thread. The insert 1 is arranged completely recessed in the outlet mouthpiece 2 on the inflow side 9, so that a sealing ring 3 placed on it on the inflow side is at least partially held radially by the outlet mouthpiece 2.

The insert 1 and the outlet mouthpiece 2 consequently form an outlet set 17 for a sanitary fitting according to the invention, which may also include the sealing ring 3.

According to the invention, on the outflow side 10, the insert 1 projects beyond the outlet mouthpiece 2, so that a projecting region 14 is easily externally visible, even from an elevated observation position 12.

FIG. 5 then shows a sanitary fitting outlet 11 as a sanitary fitting part of a sanitary fitting assembly 5 according to the invention. The sanitary fitting outlet 11 has a thread 8, into which an outlet mouthpiece 2 is screwed with its mating thread 7. According to FIGS. 1 to 4, an insert 1 and a sealing ring 3 have been inserted in the outlet mouthpiece 2. The sealing ring 3 in this case interacts with a sealing surface 16, in order to achieve a sealing effect.

It is particularly relevant here that the length of the insert 1 is dimensioned such that the insert projects on the outflow side with a region 14 beyond the outlet mouthpiece 2.

The advantage is thus that the insert 1 in the position for use is visible from a viewing direction 12 that is arranged higher than the outlet mouthpiece 2. In particular, the region 14 of the insert 1 may protrude out of the outlet mouthpiece 2 to such an extent that it is visible from a viewing direction 12 or observation position that forms an angle A of at least 20° with respect to the horizontal 13, for instance in relation to the insert 1 or in relation to the outflow-side termination 6 of the outlet mouthpiece 2. As a result, at least the projecting region 14 of the insert 1 can be identified or seen, without an observer having to bend down to enable him/her to look under the sanitary fitting assembly 5.

It may therefore be expedient if the insert 1 is of such a length on the outflow side 10 that it is also still visible at an angle A of 30°, and in particular at an angle A of 45°. To improve the visibility of the insert 1 or of the projecting region 14, the outlet mouthpiece 2 may have on the outer circumference of the outflow side 10 a peripheral bevel 15 or chamfer, which corresponds approximately to the angle A of the direction of observation 12.

The axial length of the insert 1, or of the projecting region 14, depends here on the overall height of the sanitary fitting assembly 5 and the viewing distance. If the sanitary fitting outlet 11, and consequently the outlet mouthpiece 2, lies very low over a wash basin, the necessary length of the projecting region 14 of the insert 1 is longer than in the case of a sanitary fitting assembly 5 of which the sanitary fitting outlet 11 lies very far over the wash basin. The insert 1 according to the invention can therefore also be offered in different lengths, so that a suitable length can be chosen from a number of lengths.

The full advantage of the invention is obtained when different inserts 1, or at least the projecting region 14, is/are formed in different colors.

This makes possible a use in which the insert 1 as an exchange insert, of a different color at least in a region 14 that is externally visible in the position for use, preferably over an entire main body of the insert, replaces a used insert 1.

Such a use is appropriate for example wherever inserts 1 are regularly changed for reasons of hygiene. The use of different colors thus makes it possible to see from a natural direction of observation 12, and in an easy way, whether an insert 1 has already been changed. If, for example, the insert 1 is replaced quarterly, a color may be set for each quarter. If a change is due, all that is needed is to look at the color. There is then no need for laborious documentation of the changing procedures, which makes it much easier and quicker for the exchange to be carried out.

It can also be seen from the drawings that the insert 1 is formed as planar on its outflow side 10. This outflow side 10 is consequently terminated radially by a peripheral outer edge 16. This outer edge 16 is itself externally visible, viewed obliquely from above.

A sanitary fitting assembly 5 has a sanitary fitting part 1 with a thread 8, into which an outlet mouthpiece 2 is screwed, an insert 1 and a sealing ring 3 being inserted in the outlet mouthpiece 2. The insert 1 is formed axially of such length that a region 14 projects axially beyond the outlet mouthpiece 2 on the outflow side 10. As a result, the projecting region 14 is visible from an observation position 12 at an angle A, which is greater than 20°.

### LIST OF DESIGNATIONS

1 Insert

2 Outlet mouthpiece

3 Sealing ring

4 Sealing surface

5 Sanitary fitting assembly

6 Outflow-side termination

7 Mating thread

8 Thread

9 Inflow side

10 Outflow side

11 Sanitary fitting outlet

12 Viewing direction

13 Horizontal

14 Projecting region

15 Bevel

16 Sealing surface

17 Outlet set for a sanitary fitting

A Angle

1. An outlet set (17) for a sanitary fitting comprising:
a sanitary insert (1) that is adapted to be connected to a sanitary fitting outlet (11),
an outlet mouthpiece (2), the insert (1) being inserted in the outlet mouthpiece (2) and the outlet mouthpiece (2) being adapted to be fastened on a sanitary fitting part,
the insert (1) having a length in an insertion direction such that, in a position for use, an outlet end of the insert is visible from a viewing direction (12) that is arranged higher than the outlet mouthpiece (2).

2. The outlet set (17) for a sanitary fitting as claimed in claim 1, the length is dimensioned such that the insert (1) protrudes through the outlet mouthpiece (2) and projects beyond an outflow-side termination (6) of the outlet mouthpiece (2).

3. The outlet set (17) for a sanitary fitting as claimed in claim 1, wherein the length is dimensioned such that the insert (2) is visible from a viewing direction (12) of at least 20°, to the horizontal (13) at an outflow-side termination (6) of the outlet mouthpiece (2).

4. The outlet set (17) for a sanitary fitting as claimed in claim 1, wherein the insert (1) defines on an outflow side a peripheral outer edge (16) that is substantially planar.

5. The outlet set (17) for a sanitary fitting as claimed in claim 1, wherein the insert (1) is at least one of a jet regulator or a flow regulator.

6. The outlet set (17) for a sanitary fitting as claimed in claim 1, wherein the outlet mouthpiece (2) is produced from at least one of metal or an opaque plastic.

7. The outlet set (17) for a sanitary fitting as claimed in claim 1, further comprising an exchange insert (1), with which the insert (1) is replaceable, the exchange insert (1) having a different color than the insert (1), at least in a region (14) that is externally visible in the position for use.

8. A sanitary fitting assembly (5) comprising a sanitary fitting outlet (11) and the outlet set (17) for a sanitary fitting as claimed in claim 1.

9. A method of installing a sanitary insert (1) on a sanitary fitting outlet (11), the method comprising:
inserting the sanitary insert (1) in an outlet mouthpiece (2),
fastening the outlet mouthpiece (2) on a sanitary fitting part, characterized in that the insert (1) is made to be of such a length in an inserting direction that, in a position for use, an end of the sanitary insert is visible from a viewing direction (12) that is arranged higher than the outlet mouthpiece (2).

10. The method as claimed in claim 9, further comprising dimensioning the length such that the insert (1) protrudes through the outlet mouthpiece (2) and projects beyond an outflow-side termination (6) of the outlet mouthpiece (2).

11. The method as claimed in claim 9, wherein the length is dimensioned such that the insert (1) is visible from a viewing direction (12) of at least 20°, to the horizontal (13) at the outflow-side termination (6) of the outlet mouthpiece (2).

12. The method as claimed in claim 9, wherein the insert (1) defines on an outflow side a peripheral outer edge (16) is substantially planar.

13. The method as claimed in claim 9, wherein the insert (1) is at least one of a jet regulator, a flow regulator, or a jet former.

14. The method as claimed in claim 9, wherein the outlet mouthpiece (2) is produced from at least one of a metal or an opaque plastic.

15. The method as claimed in claim 9, further comprising providing an exchange insert of a different color at least in a region that is externally visible in the position for use, and
replacing the insert (1) that has been used with the exchange insert.

16. A sanitary fitting assembly set, comprising an outlet mouthpiece (2) and at least two inserts (1), which are alternatively insertable into the outlet mouthpiece (2) and which are differently colored in a corresponding region (14) that remains externally visible in each case in a position for use.
